(19) United States
(12) Patent Application Publication
(10) Pub. No.: US 2017/0140552 A1
(43) Pub. Date: May 18, 2017

(54) APPARATUS AND METHOD FOR ESTIMATING HAND POSITION UTILIZING HEAD MOUNTED COLOR DEPTH CAMERA, AND BARE HAND INTERACTION SYSTEM USING SAME

(71) Applicant: KOREA ADVANCED INSTITUTE OF SCIENCE AND TECHNOLOGY, Daejeon (KR)

(72) Inventors: Woon Tack WOO, Daejeon (KR); Tae Jin HA, Daejeon (KR)

(21) Appl. No.: 15/321,984

(22) PCT Filed: Jun. 25, 2015
(86) PCT No.: PCT/KR2015/006508

§ 371 Date: Dec. 23, 2016

(30) Foreign Application Priority Data
Jun. 25, 2014 (KR) 10-2014-0077827
Jun. 25, 2014 (KR) 10-2014-0078154
Jun. 25, 2015 (KR) 10-2015-0090346

(51) Int. Cl. G06T 7/73; G06F 3/01; G06T 15/60; G06K 9/40; G06K 9/46; G06K 9/00; H04N 13/02; G06T 7/246

(52) U.S. Cl. CPC G06T 7/75; H04N 13/025; G06F 3/011; G06F 3/017; G06T 7/251; G06K 9/40; G06K 9/4609; G06K 9/00355; G06T 15/60; G06T 2207/10024; G06T 2207/10028; G06T 2207/30196

(57) ABSTRACT

The present invention relates to a technology that allows a user to manipulate a virtual three-dimensional (3D) object with his or her bare hand in a wearable augmented reality (AR) environment, and more particularly, to a technology that is capable of detecting 3D positions of a pair of cameras mounted on a wearable display and a 3D position of a user's hand in a space by using distance input data of an RGB-Depth (RGB-D) camera, without separate hand and camera tracking devices installed in the space (environment) and enabling a user's bare hand interaction based on the detected 3D positions.

### TECHNICAL FIELD

The present invention relates to a technology that allows a user to manipulate a virtual three-dimensional (3D) object with his or her bare hand in a wearable augmented reality (AR) environment, and more particularly, to a localization technology that is capable of discovering 3D positions of a pair of short-range/long-range depth cameras mounted on a glass-type display and a 3D position of a user's hand in a space by using distance input data of an RGB-Depth (RGB-D) camera, without separate hand and camera tracking devices installed in the space (environment) and a technology that is applicable to various 3D interaction scenarios using hands as a user interface in a wearable AR environment.

The present invention also relates to a technology that is capable of improving a user's visual distance recognition at the time of bare hand interaction in an AR environment based on such hand position estimation.

### BACKGROUND ART

With the recent developments of small-sized, lightweight head-worn displays (HWDs) and RGB-Depth (RGB-D) cameras, the advances in wearable AR are being accelerated. A mobile user can immediately view and manipulate useful digital information on an object of interest, an environment, a work, and the like through glasses in the field. There are various user interfaces for interaction of the wearable AR, but a hand-based interaction is regarded as the most intuitive and natural user input method that can be easily used.

Generally, in the study on virtual reality (VR), a separate tracking infrastructure for recognizing positions of a user's head and hand has been used for interaction with a virtual object. Accurate positions of a head and a hand can be known through a tracker installed in an environment (ceiling, table, wall, etc.)

However, a wearable AR environment having no tracker installed in such an environment presents new technical problems. First, 3D interaction is very difficult because it is difficult to know positions of a user's head and hand from a space. Some studies support interaction based a two-dimensional (2D) image input, without discovering a position of a hand in a 3D space. Alternatively, in order to sense a hand posture, a hand posture may be recognized by attaching a tracking marker or sensor to a hand or a finger or attaching a small-sized camera to a wrist. Another system discovers a relative position of a hand in a 3D space, but cannot apply to a mobile user because the system operates based on a camera fixed in a space.

In order to solve such problems, a hand object is recognized from a depth map image of an RGB-D camera, a position of a hand is estimated, and a 3D position of a bare hand is tracked based on a camera coordinate system. A position of a hand in a 3D space is estimated by using a camera position tracking method based on a simultaneous localization and mapping (SLAM). In this case, an arbitrary scale unit of a SLAM-based space matches a scale unit of mm by using depth map information. Through these methods, the user can manipulate a virtual object augmented in a SLAM-based 3D space with his or her hand.

Various six degrees of freedom (6DOF) tracking devices have been used for mapping a position and a rotation of a virtual hand to a position and a rotation of a user's real hand. For example, a Go-Go hand technology uses two electronic tracking systems for discovering a hand position of a user from an object.

In the wearable AR, a method of interaction using hands is determined by performance of a hand position estimation (localization) technology. A WearTrack system proposes head and hand trackers for wearable computer and wearable VR, but an electromagnetic tracker must be worn on a hand.

A virtual touch screen system, an AR memo, and SixthSense enable hand recognition based on a 2D image coordinate system. However, since 3D hand position estimation is not performed, 3D interaction in the wearable AR cannot be supported.

In the related art, Tinmith and FingARtips use a marker attached to a glove so as to recognize a user's hand. However, it is inconvenient for the user to wear the glove and the performance of hand recognition changes according to the magnitude and direction of the marker. HandyAR tracks fingers of a bare hand and enables a 3D manipulation of a virtual object. However, only predefined finger shapes are recognized and scaling mapping between a hand and a virtual world must be initially set.

Regarding the recent 3D hand interaction, research has been conducted to separate and recognize a hand region by using distance information contained in depth data. Also, a hand skeleton is tracked in real time by using depth cameras (e.g., a Gestigon leap motion SoftKinetic 3Gear system). However, this method is usually suitable for a desktop-based computing environment based on a camera fixed to an environment.

In the existing study on the AR, a surrounding background is learnt by using a reference marker and a stationary camera and then hand recognition is enabled. However, when the camera is moved, environment information changes and a hand separation and recognition method based on background learning may be failed.

On the other hand, in the study on the VR study, the interaction using hands generates a shadow and an occlusion effect by using a previously given virtual space model. This helps recognize a position of a target object to be manipulated.

The wearable AR uses a first person view based on an HWD. Since an image in which a virtual object is augmented in a space is rendered, a user's hand or the like is often occluded. In this case, it is difficult for the user to effectively manipulate the virtual object.

In the VR, accurate positions of a head, a hand, and a virtual object based on a world coordinate system are known in a modeled environment. Therefore, it is easy to render an occlusion model and a shadow for depth recognition.

However, in the AR, it is difficult to know whether the virtual object is in front of the hand or behind the hand. In the first person view of the wearable AR, this problem is more important and complicated. Since the virtual object augmented in the space frequently occludes the user's hand, depth recognition necessary for manipulation cannot be performed.

In order to occlude a virtual object, a hand may be made to be transparent by performing voxel rendering on 3D point clouds. However, since the virtual object is occluded by the hand, it may be difficult to confirm the presence and position of the virtual object.

### DETAILED DESCRIPTION OF THE INVENTION

### Technical Problem

The present invention has been made in an effort to solve the problems of the related art and the technical purpose of the present invention is to provide a system and a method that allow a user to manipulate a virtual 3D object with his or her bare hand in a wearable AR environment.

Also, the present invention suggests a method of rendering a user's hand with a semi-transparent voxel, transparent voxel rendering for natural occlusion of an environment, and gray voxel rendering for a shadow effect, so as to show a target object behind the hand.

### Technical Solution

An apparatus for estimating a hand position utilizing a head mounted color depth camera, according to the present invention, includes: a wearable display equipped with a color depth camera worn on a user's head and configured to capture a forward image and provide a spatially matched augmented reality (AR) image to a user; a hand object separation unit configured to separate a hand object from a depth map image acquired by the color depth camera; and a hand position acquisition unit configured to acquire a hand position by calculating a hand position in a real space and matching a virtual hand model with the hand position of the user.

Also, a method for estimating a hand position utilizing a head mounted color depth camera, according to the present invention, includes: (a) capturing an image in front of a user through a color depth camera; (b) by a hand object separation unit, separating a hand object from a depth map image acquired by a color depth camera; (c) by a hand position acquisition unit, acquiring a hand position by calculating a hand position in a real space and matching a virtual hand model with a hand position of a user; (d) providing a matched image through a wearable display; and (e) by an object manipulation unit, selecting and manipulating a virtual three-dimensional (3D) object according to a hand gesture of the user.

Also, a bare hand interaction system utilizing a head mounted color depth camera, according to the present invention, includes: a hand position estimation apparatus unit configured to extract 3D features of a hand from an image captured by a color depth camera, based on a camera coordinate system, and match a virtual hand model with a hand position of a user, based on local reference coordinates of an AR space; and a distance recognition feedback unit connected to the hand position estimation apparatus unit and configured to recognize a visual distance of the user and provide an interaction feedback.

### Advantageous Effects

The present invention has an effect that can discover 3D positions of a pair of short-range/long-range depth cameras mounted on a wearable display and a 3D position of a user's hand in a space by using distance input data of an RGB-D camera, without separate hand or camera tracking devices installed in the space (environment).

The present invention has an effect in recognizing a visual distance for distance recognition improvement at the time of interaction using hands in an AR environment through rendering of a user's hand with a semi-transparent voxel, transparent voxel rendering for natural occlusion of an environment, and gray voxel rendering for a shadow effect, so as to show a target object behind the hand.

### DESCRIPTION OF THE DRAWINGS

FIG. 1 is a configuration diagram illustrating an overall configuration of an apparatus for estimating a hand position utilizing a head mounted color depth camera, according to the present invention.

FIG. 2A to FIG. 2D are a conceptual diagram for describing technical features of the apparatus for estimating the hand position utilizing the head mounted color depth camera, according to the present invention.

FIG. 3 is a flowchart showing an overall flow of a method for estimating a hand position utilizing a head mounted color depth camera.

FIG. 4 is a diagram illustrating a configuration of a head mounted color depth camera, according to the present invention.

FIG. 5 is a diagram illustrating a hand object recognition concept in a head mounted short-range RGB-D camera, according to the present invention.

FIG. 6 is a diagram illustrating a relationship between an image and camera and world coordinate systems, according to the present invention.

FIG. 7 is a diagram illustrating a distance concept of a virtual camera, according to the present invention.

FIG. 8 is a diagram illustrating a 3D manipulation using a virtual hand, according to the present invention.

FIGS. 9A to 9E are a diagram illustrating various applicable embodiments of the present invention.

FIG. 10 is a diagram illustrating an example of a screen to which a method of improving a user's visual distance recognition is applied in a bare hand interaction system utilizing a head mounted color depth camera, according to the present invention.

FIG. 11 is a diagram illustrating a detailed configuration of a distance recognition feedback unit in the bare hand interaction system utilizing the head mounted color depth camera, according to the present invention.

FIG. 12 is a diagram illustrating an example of a screen related to a visual feedback for depth recognition improvement in the bare hand interaction system utilizing the head mounted color depth camera, according to the present invention.

FIG. 13 is a diagram illustrating an example of a screen related to a semi-transparent gray shadow and guide lines in the bare hand interaction system utilizing the head mounted color depth camera, according to the present invention.

FIG. 14 is a diagram illustrating an example of semi-transparent hand rendering related to an environment occlusion effect in the bare hand interaction system utilizing the head mounted color depth camera, according to the present invention.

### MODE OF THE INVENTION

Hereinafter, exemplary embodiments of the present invention will be described in detail with reference to the accompanying drawings. Various specific definitions found in the following description are provided only to help general understanding of the present invention, and it is apparent to those skilled in the art that the present invention can be implemented without such definitions.

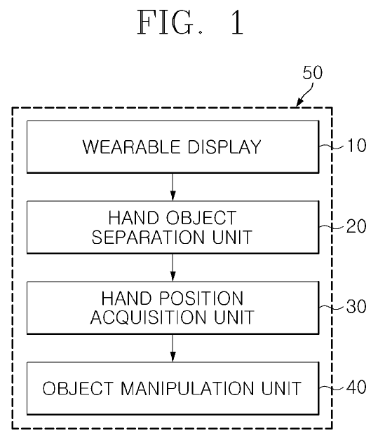

According to the present invention, as illustrated in FIG. 1, an apparatus for estimating a hand position utilizing a head mounted color depth camera includes: a wearable display 10 equipped with a color depth camera worn on a user's head and configured to capture a forward image and provide a spatially matched augmented reality (AR) image to a user; a hand object separation unit 20 configured to separate a hand object from a depth map image acquired by the color depth camera; a hand position acquisition unit 30 configured to acquire a hand position by calculating a hand position in a real space and matching a virtual hand model with the hand position of the user; and an object manipulation unit 40 configured to select and manipulate a virtual three-dimensional (3D) object according to a hand gesture of the user.

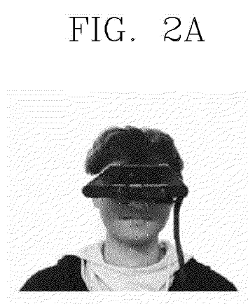

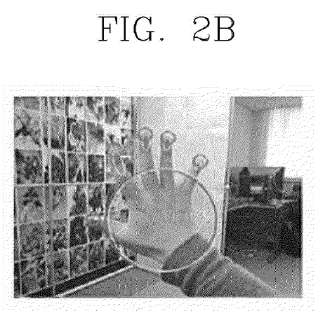

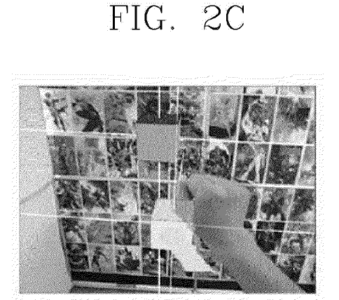

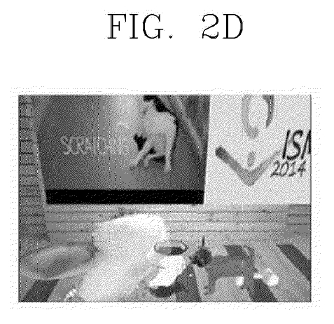

FIG. 2A to FIG. 2D is a diagram showing main features of the apparatus for estimating the hand position, according to the present invention, which allows a user to select and manipulate a virtual 3D object with his or her bare hand in a wearable AR environment by tracking a hand position without separate additional sensor devices other than a user-wearable camera.

As shown in FIG. 2A, the user wears the wearable display 10 equipped with short-range/long-range depth cameras (RGB-Depth cameras). As shown in FIG. 2B, 3D features of the hand are extracted based on camera coordinates. As shown in FIG. 2C, a virtual hand is rendered based on reference coordinates of an AR space. As shown in FIG. 2D, the user is allowed to select and manipulate the virtual 3D with his or her bare hand.

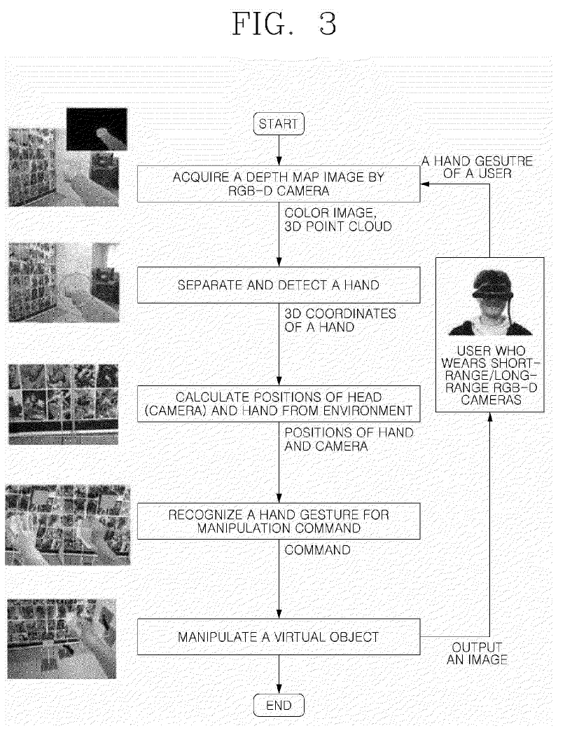

FIG. 3 is a flowchart of a method for estimating a hand position using the apparatus for estimating the hand position utilizing the head mounted color depth camera, according to the present invention. After a pair of RGB-D cameras 11 and 12 mounted on the wearable display 10 acquires a color and a depth map image, a hand object is separated based on the camera coordinate system. A virtual hand model is matched with a hand position of the user based on a local reference coordinate system (or local reference coordinates). An event of selecting or unselecting a virtual object is generated by recognizing a gesture of closing or opening a user's fist.

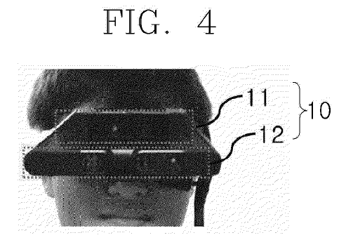

Like an embodiment illustrated in FIG. 4, the short-range depth camera 11 and the long-range depth camera 12 are coupled to the wearable display 10. The short-range depth camera 11 is used to sense a hand, and the long-range depth camera 12 is used to discover (or detect) positions of a pair of cameras from an environment and correct scale information between a physical world and a virtual world. If a camera capable of measuring a depth with various distances is developed, the two camera systems used in the present invention may be simplified into one camera system.

The short-range depth camera 11 (or the near range depth camera) is used for hand tracking, and the long-range depth camera 12 is used to acquire positions of the pair of cameras from the environment and correct scale parameters in real and virtual spaces.

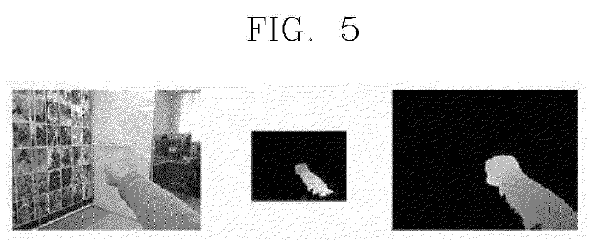

As illustrated in FIG. 5, the hand object separation unit 20 includes: a contour acquisition unit configured to separate a hand object from a depth map image acquired by the depth cameras 11 and 12, remove a noise from an image of the separated hand object, and acquire a contour having a maximum size; and a distance transform unit configured to perform distance transform to define pixel coordinates of a pixel having the highest strength as a central position of a palm.

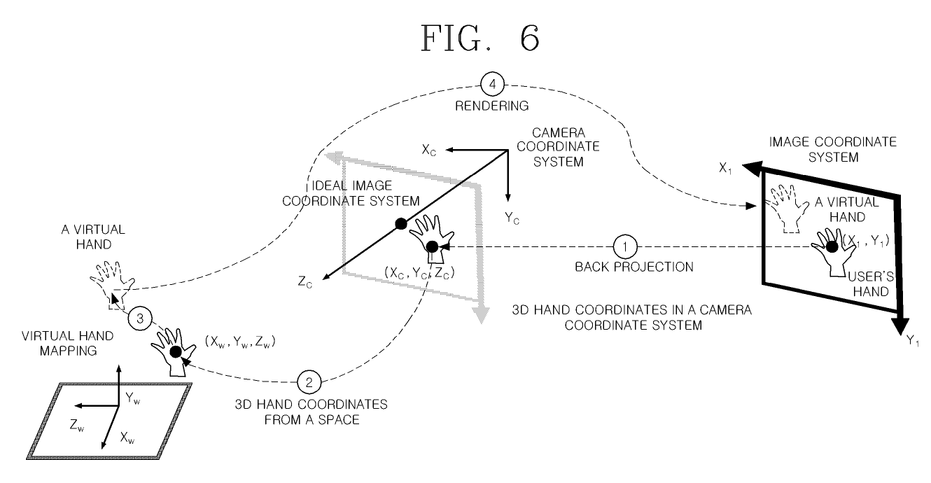

That is, as illustrated in a conceptual diagram of FIG. 6, when separating the hand object from the depth map image acquired by the depth cameras 11 and 12, the hand object separation unit 20 acquires the contour having the maximum size by performing image erosion or the like so as to reduce image jitter. Subsequently, the hand object separation unit 20 performs distance transform to define pixel coordinates of the pixel having the highest strength as the central position of the palm.

Then, the hand position acquisition unit 30 acquires the position of the user's hand. The hand position acquisition unit 30 according to the present invention includes: a hand coordinate acquisition unit configured to calculate a 3D position based on the camera coordinate system by performing back projection on pixel coordinates of the hand from the image coordinate system to the camera coordinate system and track the hand position by using a camera tracking method based on a simultaneous localization and mapping (SLAM); and a hand matching unit configured to calculate a hand position in a real space by calculating a ratio of a distance of a SLAM-based virtual camera to a distance of a depth camera with respect to local coordinates and match a virtual hand model with the hand position of the user.

More specifically, as illustrated in FIG. 6, a 3D hand position P_{C}=[X_{C}, Y_{C}, Z_{C}] is calculated based on the camera coordinate system. To this end, the back projection is performed on the pixel coordinates of the hand from the image coordinate system to the camera coordinate system (Equations 1 and 2). Herein, K is known beforehand through camera calibration. The pixel coordinates of the hand in the image coordinate system can be known from the hand object recognition that has been performed beforehand. Depth information Z_{C} can be known from a pixel value of the depth map image.

$$\begin{matrix}s [ \begin{matrix}x \\ y \\ 1\end{matrix} ] = k [ \begin{matrix}{X}_{C} \\ {Y}_{C} \\ {Z}_{C} \\ 1\end{matrix} ] = [ \begin{matrix}{f}_{x} & 0 & {c}_{x} & 0 \\ 0 & {f}_{y} & {c}_{y} & 0 \\ 0 & 0 & 1 & 0\end{matrix} ] [ \begin{matrix}{X}_{C} \\ {Y}_{C} \\ {Z}_{C} \\ 1\end{matrix} ] = [ \begin{matrix}{f}_{x} {X}_{C} + {c}_{x} {Z}_{C} \\ {f}_{y} {X}_{C} + {c}_{y} {Z}_{C} \\ {Z}_{C}\end{matrix} ] & [ Equation 1 ] \\ {X}_{c} = \frac{( x - {c}_{x} ) {Z}_{c}}{{f}_{x}} , {Y}_{C} = \frac{( y - {c}_{y} ) {Z}_{C}}{{f}_{y}} , {Z}_{C} = depth map value & [ Equation 2 ]\end{matrix}$$

Then, as expressed in Equation 3 below, the coordinates of the hand can be moved to the local reference coordinates of the environment by inversely multiplying P_{C} by a camera attitude matrix obtained by the SLAM-based camera tracking method. However, since a scale of the coordinates depends on a scale of the SLAM, the scale of the coordinates is different from the scale (mm) of the hand coordinates acquired based on the depth camera.

$$[ \begin{matrix}{X}_{W} \\ {Y}_{W} \\ {Z}_{W} \\ 1\end{matrix} ] = λ {T}_{WtoC}^{- 1} [ \begin{matrix}{X}_{C} \\ {Y}_{C} \\ {Z}_{C} \\ 1\end{matrix} ] \qquad [ Equation 3 ]$$

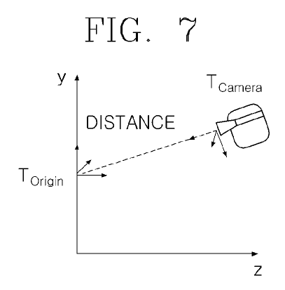

Thus, a scale ratio λ is calculated so as to match the scales of the two spaces. As illustrated in FIG. 7, a ratio of the distance of the SLAM-based virtual camera to a distance (mm) of the depth camera with respect to the local coordinates (T_{origin}) is calculated by using Equation 4 below.

$$[ Equation 4 ]$$

$$λ = \frac{‖ {D}_{virtual} = camera to origin in virtual scale units ‖}{‖ {D}_{real} = camera to origin in real scale units ‖}$$

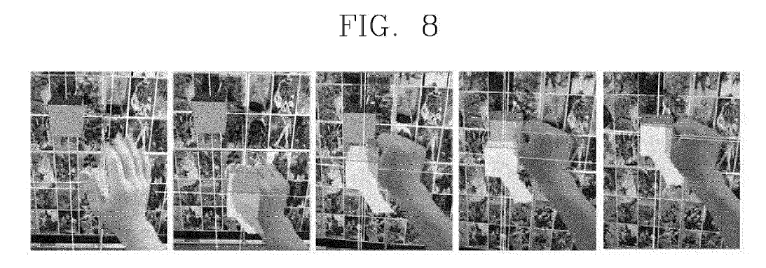

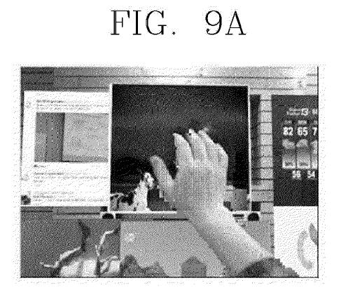

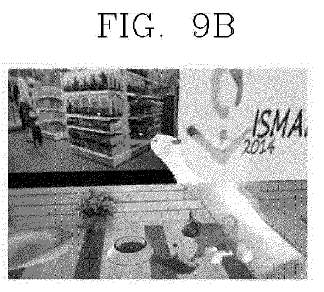

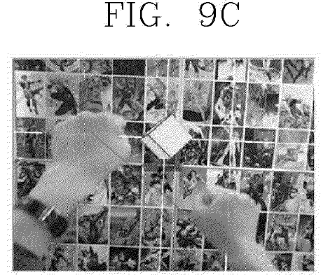

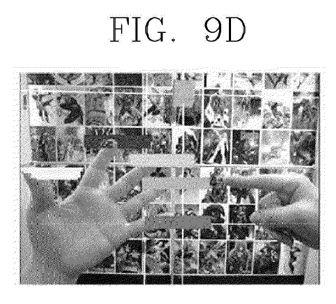

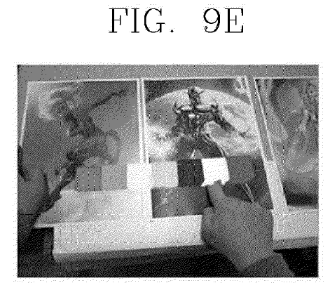

As a result, the hand position P_{W} in the environment (real space) can be calculated. As illustrated in FIG. 8 and FIGS. 9A to 9E, virtual objects matched with the environment can be manipulated with the user's hand. As expressed in Equation 5 below, the user's hand can expand to various positions P_{V} by various virtual hand mapping methods.

P_{V}=T_{Virtual}_{_}_{Hand}P_{W} [Equation 5]

A bare hand interaction system using the apparatus for estimating the hand position utilizing the head mounted color depth camera will be described below.

The bare hand interaction system utilizing the head mounted color depth camera includes: a hand position estimation apparatus unit configured to extract 3D features of a hand from an image captured by two depth cameras, based on a camera coordinate system, and match a virtual hand model with a hand position of a user, based on local reference coordinates of an AR space; and a distance recognition feedback unit connected to the hand position estimation apparatus unit and configured to recognize a visual distance of the user and provide an interaction feedback.

Since the configuration of the hand position estimation apparatus unit corresponds to the apparatus for estimating the hand position described above, additional descriptions thereof will be omitted.

In the bare hand interaction system according to the present invention, the short-range depth camera 11 among two depth cameras 11 and 12 mounted on the wearable display 10 is used to acquire 3D point clouds of the hand and generate an occlusion effect or perform semi-transparent rendering. The long-range depth camera 12 among two depth cameras 11 and 12 mounted on the wearable display 10 is used to acquire 3D point clouds of the environment and generate a shadow or occlusion effect.

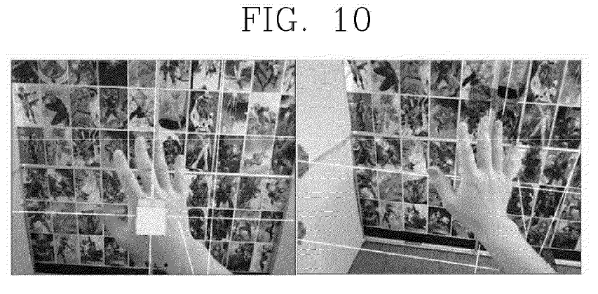

In the bare hand interaction system according to the present invention, the visual feedback is important for accurate depth recognition in a monocular display. For example, if no visual feedback is provided as illustrated on the left side of FIG. 10, depth recognition is difficult because a virtual object behind the hand looks as if the virtual object is placed on the hand. In order to solve such problems, the virtual object behind the hand may be occluded by transparently rendering the 3D point clouds acquired from the hand depth map. However, as illustrated on the right side of FIG. 10, since the virtual objects are occluded, it is difficult to confirm a position.

Therefore, according to the present invention, a visual representation of a hand is improved and a visual feedback for an environment is added, so as to improve depth recognition through the distance recognition feedback unit 60.

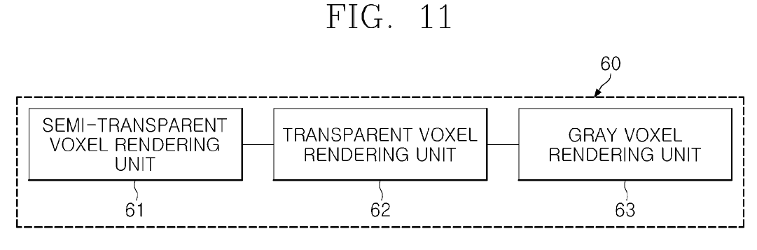

As illustrated in FIG. 11, the distance recognition feedback unit 60 includes: a semi-transparent voxel rendering unit 61 configured to display a target object behind a user's hand; a transparent voxel rendering unit 62 configured to occlude a virtual object behind a wall or a physical object through transparent voxel rendering; and a gray voxel rendering unit 63 configured to provide a shadow effect through gray voxel rendering.

That is, with regard to hand visualization, in a case where a virtual object is near the hand position, a hand occlusion effect is naturally achieved according to a depth test.

However, in a case where a virtual object is far away from the hand position, when the user selects the virtual object, the region of the object occluded by the hand is made to look slightly dark by semi-transparently visualizing the hand through the semi-transparent voxel rendering unit 61. In this manner, the user can know whether the virtual object is behind the hand or in front of the hand and can confirm the position of the object occluded by the hand.

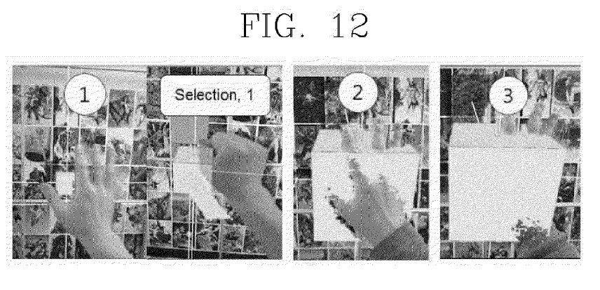

FIG. 12 is a diagram illustrating an example of a screen related to a visual feedback for depth recognition improvement in a method of improving a user's visual distance recognition at the time of bare hand interaction in an AR environment based on a head mounted display, according to an embodiment of the present invention.

As illustrated in FIG. 12, the transparent voxel rendering unit 62 uses 3D point clouds acquired by a long-range depth camera so as to generate an occlusion effect of an environment. A virtual object behind a wall or a physical object can be naturally occluded through voxel rendering that is transparent to an environment.

According to the present invention, the environment shadow effect of the gray voxel rendering unit 63 is generated by changing a previous color of a transparent voxel. This is generated in real time by projecting a shape of a manipulation object on five surfaces (front, top, bottom, left, and right).

Also, in order for precise manipulation, virtual guide lines are rendered based on the position of the manipulation object. The guide lines also are connected to five surfaces of the wearable AR space in a horizontal direction and a vertical direction.

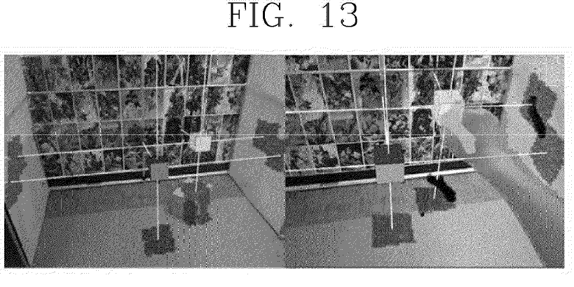

FIG. 13 is a diagram illustrating an example of a screen related to a semi-transparent gray shadow and guide lines in a method of improving a user's visual distance recognition at the time of bare hand interaction in an AR environment based on a head mounted display according to an embodiment of the present invention.

According to the present invention, when the user selects a virtual object, a color of a region of an object occluded by a hand is changed by semi-transparently visualizing the hand.

In this manner, the user can know whether the virtual object is behind the hand or in front of the hand, and can confirm the position of the object occluded by the hand.

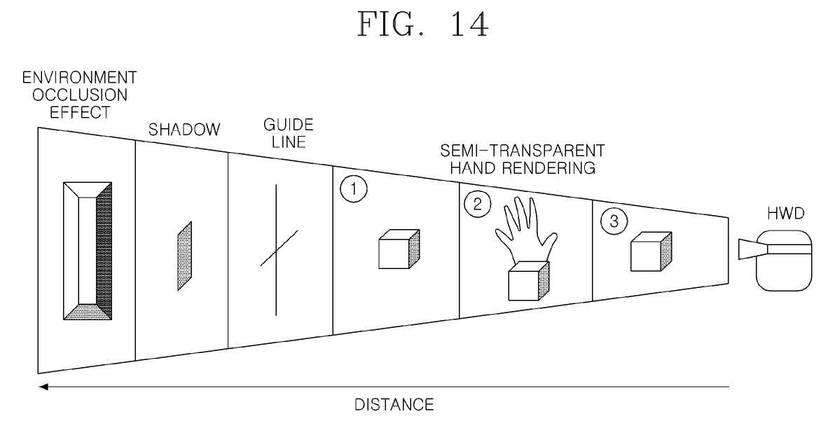

FIG. 14 is a diagram illustrating an example of semi-transparent hand rendering related to an environment occlusion effect in a method of improving a user's visual distance recognition at the time of bare hand interaction in an AR environment based on a head mounted display according to an embodiment of the present invention.

As described above, the present invention suggests the visual feedback for distance recognition improvement when the user manipulates the virtual 3D object with his or her bare hand in the AR environment where the user wears the head mounted display. In order to naturally show the target object behind the hand, the present invention suggests a method of rendering a user's hand with a semi-transparent voxel, transparent voxel rendering for a natural occlusion effect of an environment, and gray voxel rendering for a shadow effect.

The method and apparatus for estimating the hand position utilizing the head mounted color depth camera and the bare hand interaction system using the same can be operated as described above. While the present invention has been particularly shown and described with reference to exemplary embodiments thereof, it will be understood by those of ordinary skill in the art that various changes in form and details may be made therein without departing from the spirit and scope of the present invention as defined by the appended claims and their equivalents.

1. An apparatus for estimating a hand position utilizing a head mounted color depth camera, the apparatus comprising:
a wearable display equipped with a color depth camera worn on a user's head and configured to capture a forward image and provide a spatially matched augmented reality (AR) image to a user;
a hand object separation unit configured to separate a hand object from a depth map image acquired by the color depth camera; and
a hand position acquisition unit configured to acquire a hand position by calculating a hand position in a real space and matching a virtual hand model with the hand position of the user.

2. The apparatus of claim 1, wherein the color depth camera comprises:
a short-range depth camera configured to sense a hand; and
a long-range depth camera configured to acquire positions of a pair of cameras from an environment and correct scale parameters in real and virtual spaces.

3. The apparatus of claim 1, wherein the hand object separation unit comprises:
a contour acquisition unit configured to remove a noise from an image and acquire a contour having a maximum size; and
a distance transform unit configured to perform distance transform to define pixel coordinates of a pixel having a highest strength as a central position of a palm.

4. The apparatus of claim 1, wherein the hand position acquisition unit comprises:
a hand coordinate acquisition unit configured to calculate a three-dimensional (3D) position of a hand based on a camera coordinate system by performing back projection on pixel coordinates of the hand from an image coordinate system to the camera coordinate system and track a hand position by using a camera tracking method based on a simultaneous localization and mapping (SLAM); and
a hand matching unit configured to calculate a hand position in a real space by calculating a ratio of a distance of a SLAM-based virtual camera to a distance of a depth camera with respect to a local coordinate system and match a virtual hand model with the hand position of the user.

5. The apparatus of claim 1, further comprising an object manipulation unit connected to the hand position acquisition unit and configured to select and manipulate a virtual 3D object according to a hand gesture of the user.

6. A method for estimating a hand position utilizing a head mounted color depth camera, the method comprising:
(a) capturing an image in front of a user through a color depth camera;
(b) separating, by a hand object separation unit, a hand object from a depth map image acquired by a color depth camera;
(c) acquiring, by a hand position acquisition unit, a hand position by calculating a hand position in a real space and matching a virtual hand model with a hand position of a user;
(d) providing a matched image through a wearable display; and
(e) selecting and manipulating, by an object manipulation unit, a virtual three-dimensional (3D) object according to a hand gesture of the user.

7. The method of claim 1, wherein the color depth camera in (a) step comprises:
a short-range depth camera configured to sense a hand; and
a long-range depth camera configured to acquire positions of a pair of cameras from an environment and correct scale parameters in real and virtual spaces.

8. The method of claim 1, wherein (b) step comprises:
(b-1) removing, by a contour acquisition unit, a noise from an image of the separated hand object and acquiring a contour having a maximum size; and
(b-2) performing, by a distance transform unit, a distance transform to define pixel coordinates of a pixel having a highest strength as a central position of a palm.

9. The method of claim 1, wherein (c) step comprises:
(c-1) calculating, by a hand coordinate acquisition unit, a three-dimensional (3D) position of a hand based on a camera coordinate system by performing back projection on pixel coordinates of the hand from an image coordinate system to the camera coordinate system and tracking a hand position by using a camera tracking method based on a simultaneous localization and mapping (SLAM); and
(c-2) calculating, by a hand matching unit, a hand position in a real space by calculating a ratio of a distance of a SLAM-based virtual camera to a distance of a depth camera with respect to a local coordinate system and matching a virtual hand model with the hand position of the user.

10. A bare hand interaction system utilizing a head mounted color depth camera, the bare hand interaction system comprising:
a hand position estimation apparatus unit configured to extract three-dimensional (3D) features of a hand from an image captured by a color depth camera on the basis of a camera coordinate system, and match a virtual hand model with a hand position of a user on the basis of a local reference coordinate system of an AR space; and
a distance recognition feedback unit connected to the hand position estimation apparatus unit and configured to recognize a visual distance of the user and provide an interaction feedback.

11. The bare hand interaction system of claim 10, wherein the hand position estimation apparatus unit comprises:
a wearable display equipped with a color depth camera worn on a user's head and configured to capture a forward image and provide a spatially matched augmented reality (AR) image to a user;
a hand object separation unit configured to separate a hand object from a depth map image acquired by the color depth camera; and
a hand position acquisition unit configured to acquire a hand position by calculating a hand position in a real space and matching a virtual hand model with a hand position of a user.

12. The bare hand interaction system of claim 11, wherein the distance recognition feedback unit comprises:
a semi-transparent voxel rendering unit configured to display a target object behind a user's hand;
a transparent voxel rendering unit configured to occlude a virtual object behind a wall or a physical object through transparent voxel rendering; and
a gray voxel rendering unit configured to provide a shadow effect through gray voxel rendering.

13. The bare hand interaction system of claim 12, wherein the gray voxel rendering unit generates a shadow effect by changing a color of a transparent voxel generated by the transparent voxel rendering unit, and projects the shadow effect on at least one of a plurality of surfaces constituting a shape of a manipulation object.
